(19) United States
(12) Patent Application Publication
(10) Pub. No.: US 2003/0144009 A1
(43) Pub. Date: Jul. 31, 2003

(54) Method and apparatus for local positioning/tracking system using wireless access points

(76) Inventor: Dan Nowlin, Hillsboro, OR (US)

Correspondence Address: Glenn E. Von Tersch, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/059,800

(22) Filed: Jan. 28, 2002

(51) Int. Cl. H04Q 7/20

(52) U.S. Cl. 455/456; 701/201

(57) ABSTRACT

A method and apparatus for local positioning/tracking system using wireless access points is described. In one embodiment, a system is presented. The system includes a first logic block to ping a server. The system also includes a second logic block to receive a locale from the server. The system further includes a third logic block to display the locale.

In an alternate embodiment, a method is presented. The method includes receiving a ping through a wireless network. The method also includes sending data to a server. The method further includes receiving locale information and conveying the locale information to a user. The information may be conveyed by displaying the information for example.

### BACKGROUND OF THE INVENTION

1. Field of the Invention

The present invention generally relates to local wireless networks and more specifically relates to interaction between small devices and local wireless networks for the purpose of determining location information in small areas.

2. Description of the Related Art

The development of the technology industry and modular space separators has resulted in an interesting phenomenon, the cubicle farm. The cubicle farm may be embodied as a large group of cubicles in an otherwise open area within a large building or floor. Spaces that typically would either be warehouses or subdivided hard shell offices may take on the form of multitudes of cubicles, with few obvious guideposts.

More recently, wireless technology has emerged in the form of wireless networks well suited for use within cubicle farms, reducing required cabling and rerouting of physical resources when movement occurs within a cubicle farm. Such a wireless network may be formed of a grid of Bluetooth (as specified in “Specification of the Bluetooth System”, Version 1.1, bearing a publication date of Feb. 22, 2001 and available from the “www.bluetooth.com” website) or 802.11 (such as is described in the ANSI/IEEE Std 802.11,1999 edition document) antennas with a server or group of servers connected to the antennas. Furthermore, as will be appreciated, a map of a location including the grid of antennas may be encoded in a machine-readable form.

While all of this technology is helpful for someone who knows the layout of the cubicle farm, it also potentially may be employed to aid those who do not know the layout of a cubicle farm, without a requirement of a GPS or similar locating device.

### BRIEF DESCRIPTION OF THE DRAWINGS

The present invention is illustrated by way of example and not limitation in the accompanying figures.

FIG. 1 illustrates an embodiment of a system suitable for use in a local positioning and tracking system.

FIG. 2 illustrates an embodiment of a system suitable for use in a local positioning and tracking system in schematic form.

FIG. 3 illustrates an alternate embodiment of a system.

FIG. 4 illustrates another alternate embodiment of a system. to FIG. 5 illustrates an embodiment of a method suitable for use in a local positioning and tracking system.

FIG. 6 illustrates an alternate embodiment of a method suitable for use in a local positioning and tracking system.

FIG. 7 illustrates another alternate embodiment of a method suitable for use in a local positioning and tracking system.

FIG. 8 illustrates yet another alternate embodiment of a method suitable for use in a local positioning and tracking system.

FIG. 9 illustrates still another embodiment of a method suitable for use in a local positioning and tracking system.

FIG. 10 illustrates yet another embodiment of a method suitable for use in a local positioning and tracking system.

FIG. 11a illustrates an embodiment of a medium suitable for use in a local positioning and tracking system.

FIG. 11b illustrates an alternate embodiment of a medium suitable for use in a local positioning and tracking system.

### DETAILED DESCRIPTION

A method and apparatus for local positioning/tracking system using wireless access points is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In one embodiment, a method is presented. The method includes receiving a ping through a wireless network. The method also includes sending data to a server. The method further includes receiving locale information and conveying the locale information to a user. The information may be conveyed by displaying the information for example.

In an alternate embodiment, another method is presented. The method includes pinging a remote device through a wireless network. The method also includes receiving a response from the remote device. The method further includes determining a locale of the remote device based on receiving the response of the remote device and sending the locale as locale information data to the remote device.

In yet another alternate embodiment, a system is presented. The system includes a processor, a control hub coupled to the processor, a memory coupled to the control hub, an i/o hub coupled to the control hub, and a wireless network interface coupled to the i/o hub. The processor is to ping a remote device through a wireless network, the wireless network coupled to the wireless network interface. The processor is also to receive a response from the remote device. The processor is further to determine a locale of the remote device based on receiving the response of the remote device. The processor is also to send the locale as locale information data to the remote device. The processor may, in some embodiments, ping, receive the response, determine the locale, and send the locale responsive to instructions. In an alternate embodiment, a machine-readable medium embodying instructions is presented, the instructions, when executed by a processor, cause the processor to perform a method.

In still another alternate embodiment, a system is presented. The system includes a first logic block to ping a server. The system also includes a second logic block to receive a locale from the server. The system further includes a third logic block to display the locale.

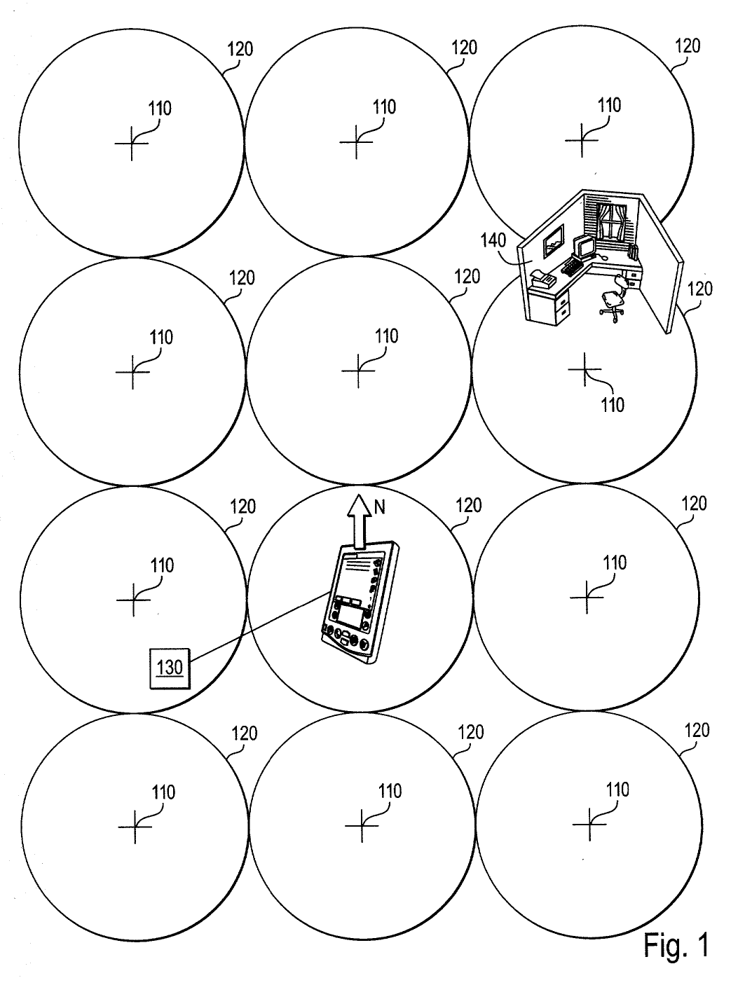

FIG. 1 illustrates an embodiment of a system suitable for use in a local positioning and tracking system. A grid of antennas 110 is provided, each coupled to a server (not shown) for use in a bluetooth or 802.11 network for example. Each antenna 110 has associated with it an effective signal radius 120. Note that such a radius may be based on a given power level for the antenna, such that the antenna, with a predetermined power setting, can be expected to broadcast a useful signal only within the space limited by the radius 120. The coupling of the antennas 110 to the server may be through use of cables or some other well known coupling method or apparatus, such that while an immediate physical attachment to the server may not exist, some form of connection suitable for communication or exchange of electrical signals exists.

[Does this work with both bluetooth and 802.11??? I think we only discussed bluetooth. ]

Device 130, in one embodiment a PDA or similar device having a built-in or attached antenna, may be used to communicate over the radio frequency spectrum with antennas 110. The server may determine which of antennas 110 is closest to device 130, and provide that information to device 130 in a variety of forms. Device 130 may then display location information, and may further display travel direction information as appropriate. Furthermore, when a destination or goal 140 is provided, device 130 may display information indicating a preferred direction for discovering or arriving at goal 140.

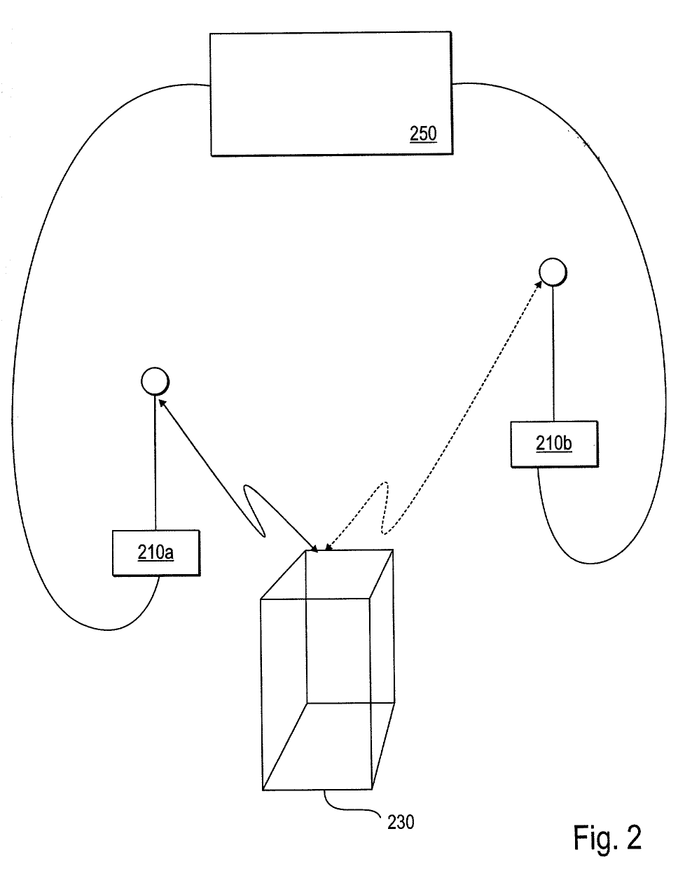

FIG. 2 illustrates an embodiment of a system suitable for use in a local positioning and tracking system in schematic form. Device 230 includes an antenna which in turn interfaces or communicates with one or both of antennas 210a and 210b. Each of antennas 210a and 210b are coupled to server 250, such as through cables. Server 250 may determine which of antennas 210a and 210b are closest through a variety of methods. For example, a determination of received signal strength at antennas 210a and 210b may indicate which antenna is closest to device 230. Alternatively, power output from either device 230 or antennas 210a and 210b may be reduced until one signal path provides such a degraded signal as to undermine reliability in communications. In such an instance, the signal path still providing reliable communications is shorter, and the corresponding antenna is closer.

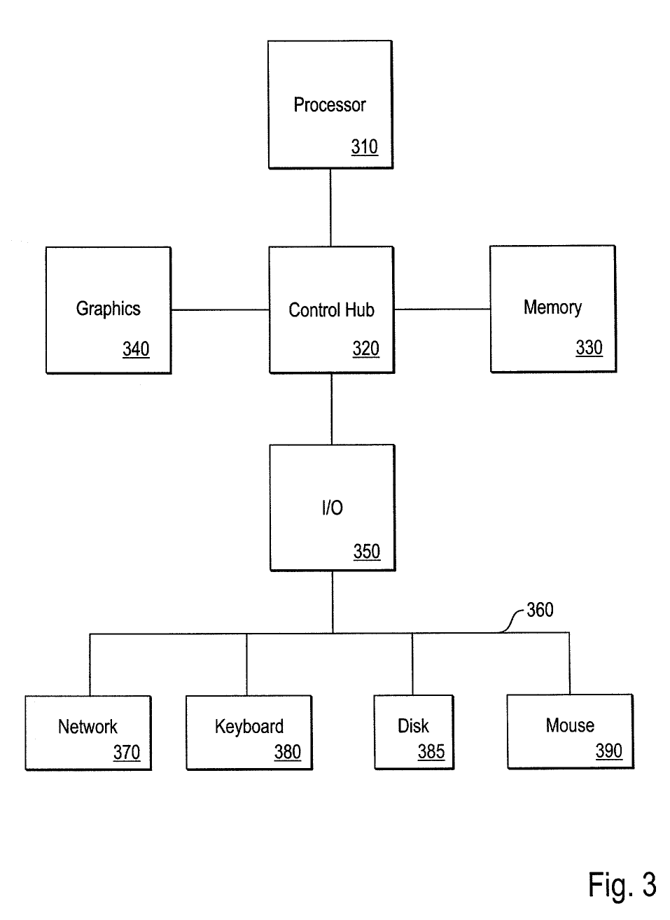

FIG. 3 illustrates an alternate embodiment of a system. Processor 310 is coupled to control hub 320. Control hub 320, in turn, is coupled to each of memory 330, graphics block 340 and I/O interface 350. In one embodiment, I/O interface 350 is coupled to a bus 360, which may in turn be coupled to other components. Bus 360 is coupled to network 370, keyboard 380, disk drive 385 and mouse 390. Effectively, I/O interface 350 is then coupled to each of network interface 370, keyboard 380, disk drive 385 and mouse 390, too.

The system including the processor 310, control hub 320 and I/O interface 350, in one embodiment, may be used to communicate with other devices using the Bluetooth protocol or the 802.11 protocol. For example, communications through network interface 370 may involve communication via an 802.11 or bluetooth radio. The servers described with respect to FIGS. 1 and 2 may have an embodiment or implementation similar to that described with respect to FIG. 3, with the multiple antennas coupled to network interface 370 (or connected via cables for example).

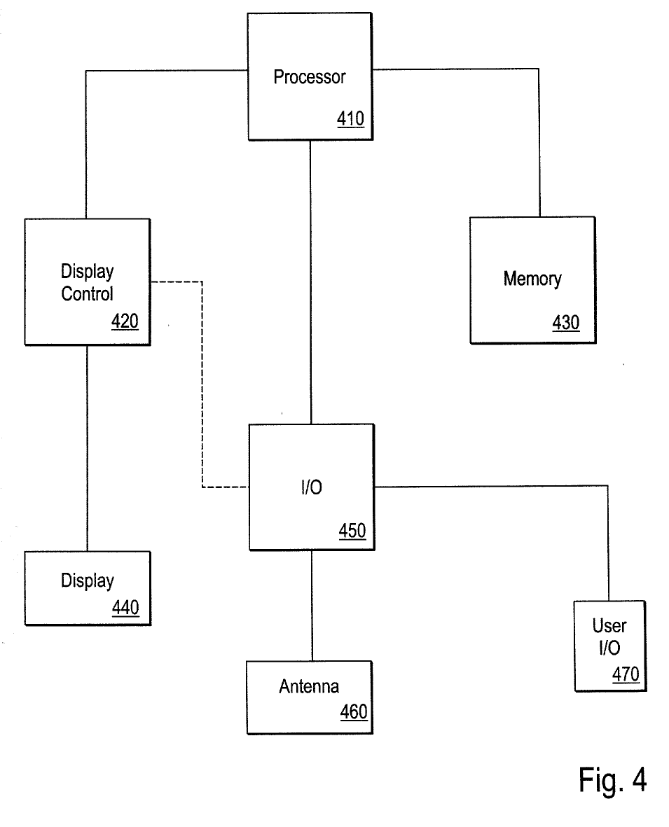

FIG. 4 illustrates another alternate embodiment of a system. In one embodiment, the system of FIG. 4 is a PDA. Note that within the context of the present application, the term PDA has a broad definition, including palmtop devices, handheld devices, wireless email terminals, and many other similar devices suitable for relatively easy portable use by a consumer. Processor 410 is coupled to display control 420 and memory 430. Display control 420 is coupled to display 440. I/O control 450 is coupled to processor 410, and may be coupled to or combined with display control 420 (such as in some implementations of touch-or pressure-sensitive displays for example). I/O control is also coupled to antenna 460 and user I/O interface 470. Note that the same or similar components may be used in both the computer system and the PDA in some embodiments of each. Moreover, note that the description with respect to FIG. 4 may be suitable for some implementations of the devices 130 and 230 of FIGS. 1 and 2. Furthermore, note that the device with respect to FIG. 4 may send and receive signals through use of antenna 460.

FIG. 5 illustrates an embodiment of a method suitable for use in a local positioning and tracking system. At block 510, a remote device (such as a PDA for example) pings a server, such as through use of a bluetooth or 802.11 wireless network. At block 520, the remote device receives locale information from the server, which the server has presumably determined based on how or where the ping signal was received. At block 530, the remote device displays the locale information in a manner suitable for use by a user, such as by providing a readable address or providing a map with an icon indicating a present location. At block 540, the remote device calculates direction or travel information, such as a direction toward a goal or a direction of travel based on a previous location. At block 550, travel information is displayed, such as by displaying an arrow on the map with the icon, or by displaying a direction in text. Note that in some embodiments, travel calculations depend on an available map or location database with parameters providing some form of grid from which travel may be calculated. For example, the grid pattern of FIG. 1 may be encoded in a database and an application may then either calculate direction of travel or direction of goal based on coordinates of the current location and a prior location (travel) or desired location (goal).

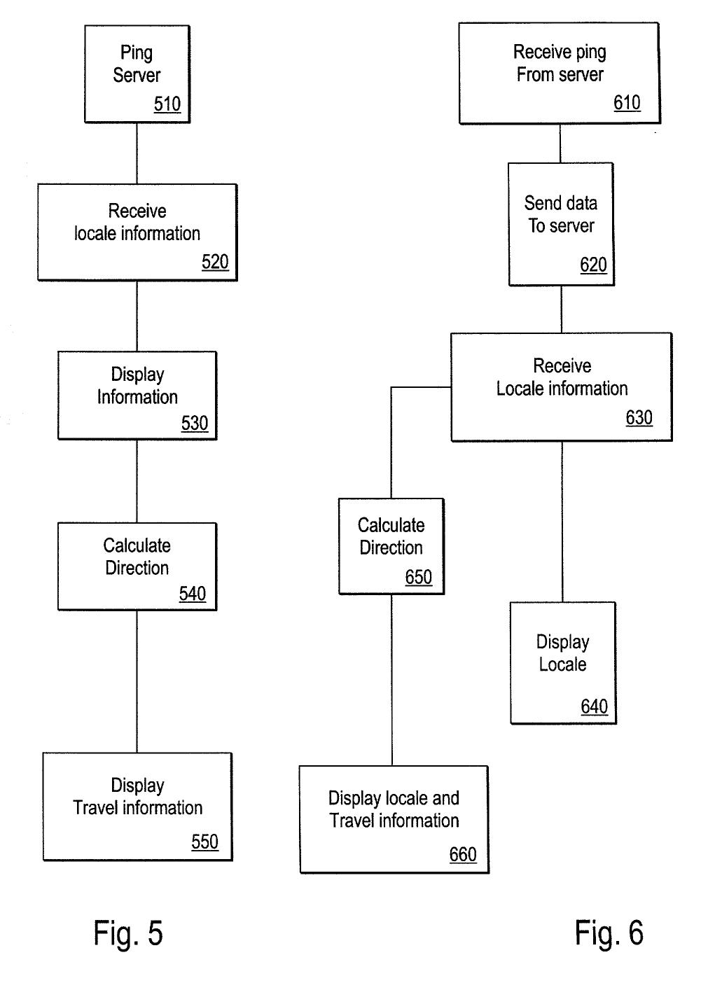

FIG. 6 illustrates an alternate embodiment of a method suitable for use in a local positioning and tracking system. At block 610, a ping is received by a remote device (such as a PDA for example) from a server via a wireless network. At block 620, data is sent by the remote device to the server in response to the ping. At block 630, locale information is received by the remote device from the server, presumably after the server calculates or otherwise determines the location of the remote device. At block 640, the locale information is displayed. Alternatively, the process may flow from block 630 to block 650, for calculation of direction of travel or direction to goal within the remote device. Such a calculation likely will involve access to a local copy of a database or other encoding of map locations. At block 660, information on both location and travel is displayed.

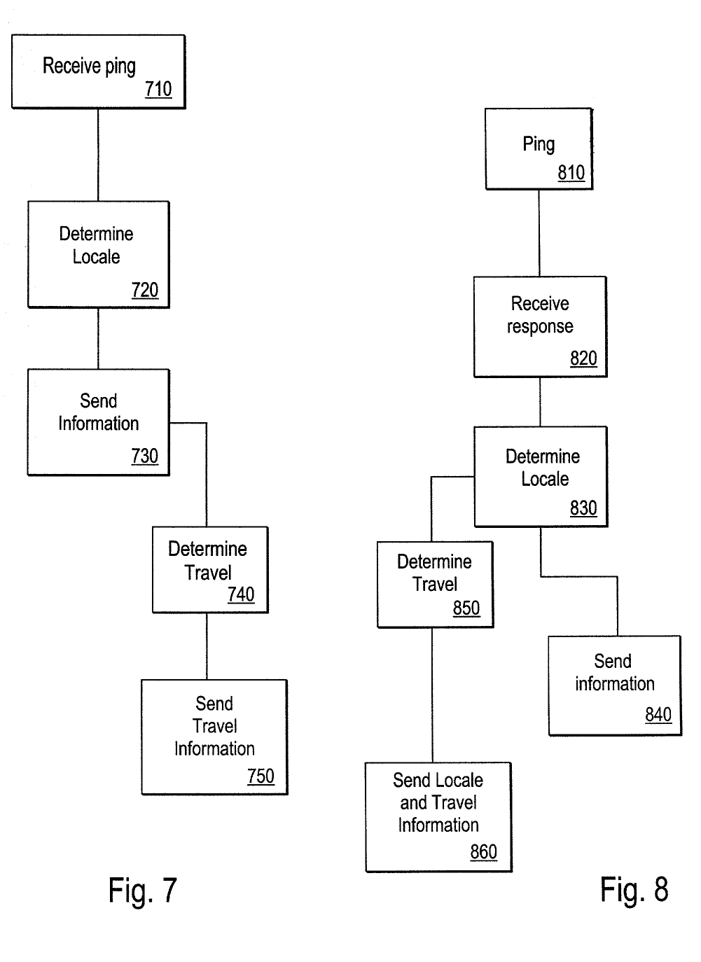

FIG. 7 illustrates another alternate embodiment of a method suitable for use in a local positioning and tracking system. At block 710, a ping is received by a server from a remote device through a wireless network. At block 720, a locale of the remote device is determined, such as by determining which node of the wireless network detected the ping, or by exchanging signals with the remote device to narrow down the locale to a node of the wireless network. At block 730, the information about the locale is sent to the remote device. Potentially, this is the end of the method. Alternatively, at block 740, a direction of travel of the remote device is determined (or a direction to a goal if a goal is known or supplied by the remote device), and at block 750, the travel information is sent to the remote device.

FIG. 8 illustrates yet another alternate embodiment of a method suitable for use in a local positioning and tracking system. At block 810, a ping is sent to a remote device by a server through a wireless network coupled to the server. Such a ping may be a signal sent out of all of the nodes of the network at one time, or serially rotated through each node for example. At block 820, a response is received. Such a response may be received at a single node or at multiple nodes. Based on the response, and potentially on further communication to triangulate or narrow down potential locations, a locale is determined at block 830. At block 840, locale information is sent to the remote device. Alternatively, at block 850, travel information is determined, and at block 860, the travel and locale information is sent to the remote device.

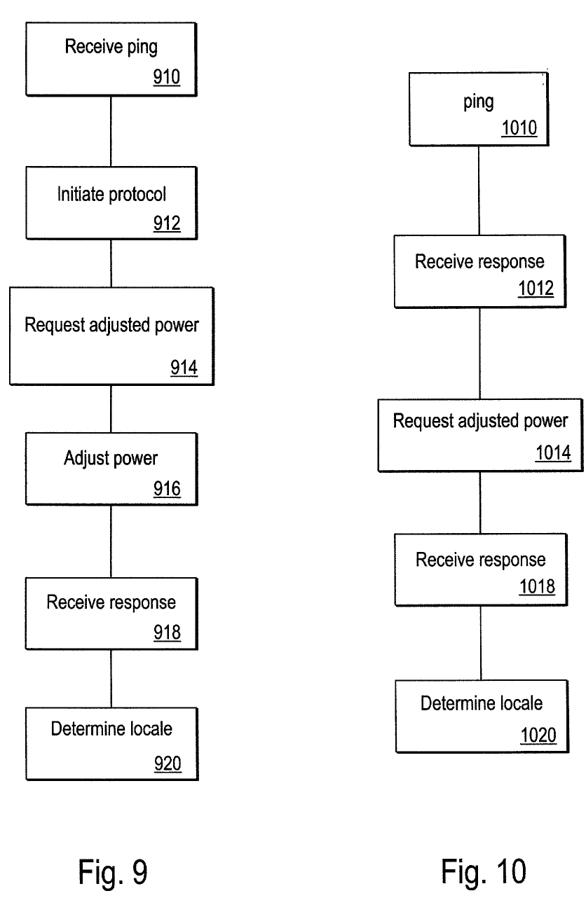

FIG. 9 illustrates still another embodiment of a method suitable for use in a local positioning and tracking system. At block 910, a ping is received, such as by a remote device. At block 912, an exchange or communications protocol is initiated, possibly including a request for a locale and/or travel information, and potentially also including a goal or recent location. At block 914, a request to adjust output power of the remote device is received, as may be necessary to reduce duplication of signals or multi-path effects in a wireless network. At block 916, the output power is reduced and further communication occurs. At block 918, a response is received including locale and/or travel information, and at block 920, a determination is made as to the contents of the response. As will be appreciated, the process of FIG. 9 may apply to communication by a remote device in the processes outlined with respect to FIGS. 5 and 6 for example.

FIG. 10 illustrates yet another embodiment of a method suitable for use in a local positioning and tracking system. At block 1010, a device is pinged, such as a remote device. At block 1012, a response is received from the remote device. At block 1014, a request is made for an adjustment in output power of the remote device, potentially reducing multi-path or interference effects in a wireless network. At block 1018, a response is received from the remote device. At block 1020, a locale of the remote device is determined, based on what node received the response. As will be appreciated, the process of FIG. 10 may be suitable for use by a server in implementing the processes described with respect to FIGS. 7 and 8. Furthermore, as will be appreciated, the processes for FIGS. 9 and 10 depend on the server to ping the remote device. As will be appreciated, the remote device may also ping the server and still achieve a similar process, one within the spirit and scope of the present invention.

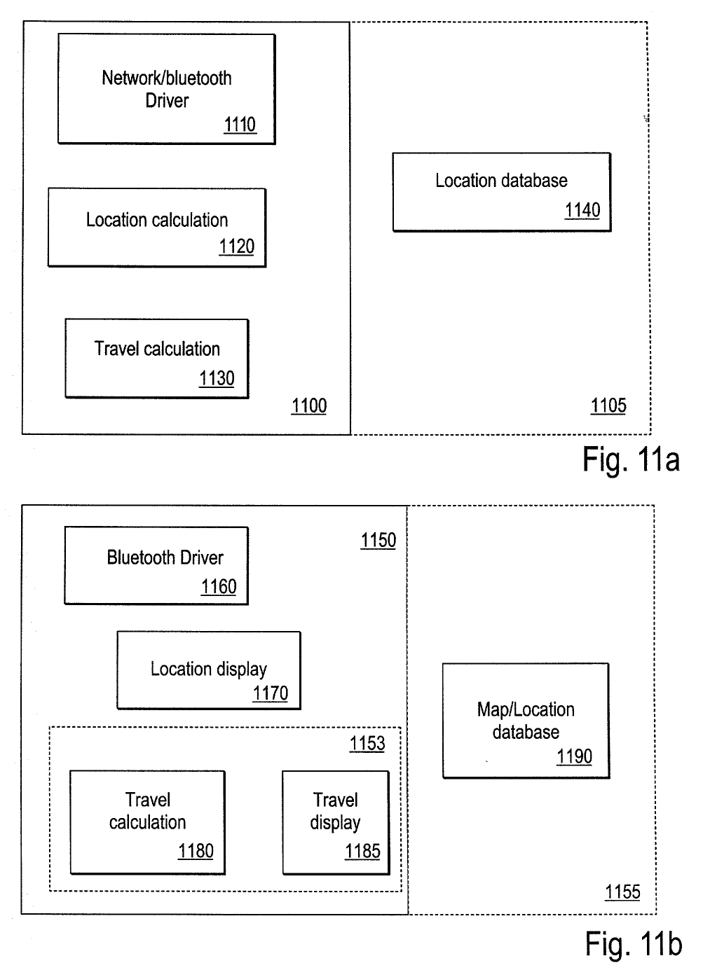

FIG. 11a illustrates embodiments of a medium suitable for use in a local positioning and tracking system. Block 1110 is a network driver, such as bluetooth driver, suitable for sending and receiving information on a wireless network. Block 1120 is a location calculation module, suitable for utilizing information such as a node identification of a receiving node of a network in conjunction with available network map information to determine a physical location corresponding to the node. Block 1130 is a travel calculation module, suitable for calculating the difference between a current location and either a past or future location to determine a direction of travel, such as a vector between two points of a grid. Each of block 1110, 1120 and 1130 are part of medium 1100. Medium 1105 may include not only medium 1100, but also a location database block 1140, such as a database or map of network node locations and corresponding network node identifiers.

FIG. 11b illustrates alternate embodiments of a medium suitable for use in a local positioning and tracking system. Block 1160 is a bluetooth driver or similar driver suitable for use with a wireless network. Block 1170 is a location display module, suitable for using a supplied location to display the supplied location, either through lookup in a database or through transformation of the supplied location into a user-friendly format. Block 1180 is a travel calculation module suitable for calculating a direction of travel based on a current location and either a previous location or a desired location. Block 1185 is a travel display module, suitable for displaying the results of block 1180 in a user-friendly form. Note that medium 1153 includes blocks 1180 and 1185. Medium 1150 includes blocks 1160 and 1170, and may also include medium 1153 or incorporate the contents of medium 1153. Medium 1155 is a medium including medium 1150 or the contents thereof, and block 1190, a map/location database module, which may be suitable for use by the travel calculation module 1180, and/or the display modules 1185 and 1170 to determine either a location or a display for a location.

As will be appreciated, in one embodiment, the device of FIG. 4 may be used with the medium of FIG. 11b. Similarly, in one embodiment, the device of FIG. 3 may be used with the medium of FIG. 11a. In each embodiment, the medium may be embodied in the memory of the device or system.

Some portions of the detailed description are presented in terms of algorithms and symbolic representations of operations on data bits within a computer memory. These algorithmic descriptions and representations are the means used by those skilled in the art to most effectively convey the substance of their work to others skilled in the art. An algorithm as described here is generally conceived to be a self consistent sequence of acts or operations leading to a desired result. The acts are those requiring physical manipulations of physical quantities. Usually, though not necessarily, these quantities take the form of electrical or magnetic signals capable of being stored, transferred, combined, compared and otherwise manipulated. It has proven convenient at times principally for reasons of common usage to refer to these signals as bits, values, elements, symbols, characters, terms, numbers, data or the like.

It should be borne in mind, however, that all of these in similar terms are to be associated with the appropriate physical quantities and are merely convenient labels applied to these quantities. Unless specifically stated otherwise as apparent from the following discussion it is appreciated that throughout the description discussions utilizing terms such as “processing” or “computing” or “calculating” or “determining” or “displaying” or the like refer to the action and processes of a computer system or similar electronic computing device that manipulates and transforms data represented as physical (electronic) quantities within the computer systems registers and memories into other data similarly represented as physical quantities within the computer system memories or registers or other such information storage transmission or display devices. The present invention can be implemented by an apparatus for performing the operations herein. This apparatus may be specially constructed for the required purposes or it may comprise a machine such as a general purpose computer selectively activated or reconfigured by a computer program stored in the computer. Such a computer program may be stored in a machine readable storage medium such as but not limited to any type of disk including floppy disks, optical disks, CD roms and magnetic optical disks, read only memories, random access memories, EPROMS, EEPROMS, magnetic or optical cards or any type of media suitable for storing electronic constructions and each coupled to a computer system bus. Each of these media may be coupled to a computer system bus through use of an appropriate device for reading and or writing the media in question. Specialty apparatus may include a collection of readily available pieces or an application specific integrated circuit including a series of logic blocks for example. The blocks of FIGS. 7, 8, 9, 11a or 11b may be suitable for implementation as logic blocks, as may other configurations of the method, system and apparatus described herein.

The algorithms and displays presented herein are not inherently related to any particular computer or other apparatus. Various general purpose systems may be used with programs in accordance with the teachings herein or it may prove convenient to construct more specialized apparatus to perform the required method. For example, any of the methods according to the present invention can be implemented in hard-wired circuitry by programming a general purpose processor or by any combination of hardware and software. One of skill in the art will immediately appreciate that the invention can be practiced with computer system configuration. Configurations other than those described below including hand held devices, multi processor systems, microprocessor based or programmable consumer electronics, network PCs, mini computers, main frame computers and the like. The invention may also be practiced in distributed computing environments or tasks or performed by remote processing devices that are linked through a communications network. The required structure for a variety of these systems will appear from the description below.

The methods of the invention may be implemented using computer software. If written in a programming language conforming to a recognized standard sequences of instructions designed to implement the methods can be compiled for execution on a variety of hardware platforms or machines and for interface to a variety of operating systems. In addition the present invention is not described with reference to any particular programming language. It will be appreciated that a variety of programming languages may be used to implement the teachings of invention as described herein. Furthermore, it is common in the art to speak of software in one form or another (for example program procedure application etc . . . ) as taken in action or causing a result. Such expressions are merely a shorthand way of saying that execution of the software by a computer causes the processor of the computer to perform an action or produce a result.

In the foregoing detailed description, the method and apparatus of the present invention has been described with reference to specific exemplary embodiments thereof. It will, however, be evident that various modifications and changes may be made thereto without departing from the broader spirit and scope of the present invention. In particular, the separate blocks of the various block diagrams represent functional blocks of methods or apparatuses and are not necessarily indicative of physical or logical separations or of an order of operation inherent in the spirit and scope of the present invention. For example, the various blocks of FIG. 3 may be integrated into components, or may be subdivided into components. Similarly, the blocks of FIGS. 5, 6, 7 and 8 (for example) represent portions of methods which, in some embodiments, may be reordered or may be organized in parallel rather than in a linear or step-wise fashion. The present specification and figures are accordingly to be regarded as illustrative rather than restrictive.

[image]

[image]

What is claimed is:

1. A method comprising:
Receiving a ping through a wireless network;
Sending data to a server;
Receiving locale information; And
Conveying the locale information to a user.

2. The method of claim 1 further comprising:
Receiving direction information; And
Conveying the direction information to the user.

3. The method of claim 1 further comprising:
Calculating direction information; and
Conveying the direction information to the user.

4. The method of claim 1 further comprising:
Initiating a communications protocol; and
Adjusting power output responsive to the communications protocol.

5. The method of claim 4 further comprising:
Receiving direction information; And
Conveying the direction information to the user.

6. The method of claim 4 further comprising:
Calculating direction information; and
Conveying the direction information to the user.

7. A method comprising:
pinging a remote device through a wireless network;
receiving a response from the remote device;
determining a locale of the remote device based on receiving the response of the remote device; and
sending the locale in a locale information data to the remote device.

8. The method of claim 7 wherein:
Determining the locale includes determining which antenna of a plurality of antennas of the wireless network received the response.

9. The method of claim 8 further comprising:
Receiving the response from the remote device includes receiving the response through multiple antennas of the plurality of antennas;
Requesting a power output adjustment from the remote device;
And receiving a second response through a single antenna of the plurality of antennas.

10. The method of claim 7 wherein:
Determining the locale includes matching a first antenna of a plurality of antennas of the wireless network to a physical location of the first antenna, the first antenna having received the response of the remote device.

11. The method of claim 9 wherein:
Determining the locale includes matching a first antenna of a plurality of antennas of the wireless network to a physical location of the first antenna, the first antenna being the single antenna.

12. A system comprising:
a processor;
a control hub coupled to the processor;
a memory coupled to the control hub;
an i/o hub coupled to the control hub;
a wireless network interface coupled to the i/o hub;
wherein the processor to:
ping a remote device through a wireless network, the wireless network coupled to the wireless network interface;
receive a response from the remote device;
determine a locale of the remote device based on receiving the response of the remote device; and
send the locale as locale information data to the remote device.

13. The system of claim 12, wherein the processor further to:
Receive the response from the remote device through multiple antennas of a plurality of antennas of the wireless network;
Request a power output adjustment from the remote device;
And receive a second response through a single antenna of the plurality of antennas.

14. The system of claim 12 wherein the processor further to:
Receive the response from the remote device through multiple antennas of a plurality of antennas of the wireless network;
Repeatedly request a power output adjustment from the remote device until a second response is received through a single antenna of the plurality of antennas.

15. The system of claim 14 wherein the processor to:
match a first antenna of a plurality of antennas of the wireless network to a physical location of the first antenna to determine a locale of the remote device, the first antenna having received the second response of the remote device.

16. The system of claim 15 wherein the processor to:
Lookup the first antenna in a lookup table in the memory and determine the physical location of the first antenna from a corresponding physical location found in the lookup table.

17. A machine-readable medium embodying instructions, the instructions, when executed by a processor, causing the processor to perform a method, the method comprising:
Receiving a ping through a wireless network;
Sending data to a server;
Receiving locale information; And
Conveying the locale information to a user.

18. The machine-readable medium of claim 17 further embodying instructions, the instructions, when executed by the processor, causing the processor to perform the method further comprising:
Receiving direction information; And
Conveying the direction information to the user.

19. The machine-readable medium of claim 17 further embodying instructions, the instructions, when executed by the processor, causing the processor to perform the method further comprising:
Calculating direction information; and
Conveying the direction information to the user.

20. An apparatus comprising:
means for pinging a remote device through a wireless network;
means for receiving a response from the remote device;
means for determining a locale of the remote device based on receiving the response of the remote device; and
means for sending the locale as locale information data to the remote device, the means for sending, the means for receiving and the means for pinging all using the wireless network.

21. The apparatus of claim 20, further comprising:
the means for receiving the response from the remote device further for receiving the response through multiple antennas of the plurality of antennas;
means for requesting a power output adjustment from the remote device;
And the means for receiving a response further for receiving a second response through a single antenna of the plurality of antennas.

22. The apparatus of claim 21 further comprising:
the means for determining the locale for matching a first antenna of a plurality of antennas of the wireless network to a physical location of the first antenna, the first antenna having received the response of the remote device.

23. A system comprising:
a first logic block to ping a server;
a second logic block to receive a locale from the server; and
a third logic block to display the locale.

24. The system of claim 23 further comprising:
A fourth logic block to receive a direction from the server; and
A fifth logic block to display the direction.

25. The system of claim 23 further comprising:
A fourth logic block to calculate a direction based on the locale; and
A fifth logic block to display the direction.
